(19) United States
(12) Patent Application Publication
(10) Pub. No.: US 2017/0291657 A1
(43) Pub. Date: Oct. 12, 2017

(54) Human-Propellable Vehicle

(71) Applicant: Gower College Swansea, Swansea South Glamorgan (GB)

(72) Inventors: Calvin John Llewelyn Williams, Swansea South Glamorgan (GB); Paul Howard Davies, Ammanford Dyfed (GB)

(21) Appl. No.: 15/512,536

(22) PCT Filed: Sep. 18, 2015
(86) PCT No.: PCT/GB2015/052702

§ 371 Date: Mar. 17, 2017

(30) Foreign Application Priority Data
Sep. 19, 2014 (GB) 1416609.4

(51) Int. Cl. B62J 25/00; A61G 5/12

(52) U.S. Cl. CPC B62J 25/00; A61G 5/128; B62K 5/003

(57) ABSTRACT

The present invention relates to a human-propellable vehicle comprising a chassis and a footplate for receiving a rider's feet. The footplate is movably mounted to the chassis so that at least part of the footplate can be deflected up towards the rider in the event of a collision between the underside of the footplate and an object or terrain passing under the chassis.

### FIELD OF THE INVENTION

The present invention relates to a human-propellable vehicle. Embodiments of the present invention relate to a three or four-wheeled bike with a footplate.

### BACKGROUND OF THE INVENTION

A four-wheel mountain bike requires a support for the rider's feet. Such a support is commonly in the form of a metal footplate mounted solidly to the main chassis of the bike. In order for the footplate to be in a position which is comfortable for the rider, it should preferably be the part of the bike which is closest to the ground (excepting the wheels). However, a problem associated with this is that if the underside of the footplate comes into contact with an obstacle or terrain feature on the ground, the bike may be forced upwards in a direction away from the obstacle. This may result in instability of the bike during riding and may cause the bike to roll over and eject the rider. The present invention seeks to solve the above problem.

### SUMMARY OF THE INVENTION

According to an aspect of the present invention, there is provided a human-propellable vehicle comprising a chassis and a footplate for receiving a rider's feet, the footplate being movably mounted to the chassis so that at least part of the footplate can be deflected up towards the rider in the event of a collision between the underside of the footplate and an object or terrain passing under the chassis.

By providing a moveable footplate which can be deflected upwards in the event of a collision, the rest position of the footplate can be kept as low as possible to increase comfort, but the footplate can be deflected upwards away from an obstacle in the event of a collision with the underside of the footplate, thereby isolating any ground strikes from the main chassis such that the main chassis of the bike remains relatively stable. In this way, the collision will not force the entire vehicle away from the ground, and will not break the footplate. More generally, the stability and safety of the bike is improved. Therefore, the present invention reduces the chance of the bike becoming unstable, rolling over and ejecting the rider.

Preferably, the footplate is mounted to the chassis by a first mounting assembly, the first mounting assembly being arranged to permit the footplate to pivot about a substantially horizontal axis, the horizontal axis being perpendicular to the longitudinal axis of the vehicle. The first mounting assembly may comprise a hinge joint or a pivot joint.

The first mounting assembly may comprise one or more first mounting units each comprising a first part fixedly attached to one of the chassis and the footplate and a second part fixedly attached to the other of the chassis and the footplate, the first part and the second part being hingedly or pivotally engaged with each other. While the first mounting assembly could comprise only a single mounting unit, for example mounted at the longitudinal axis of the vehicle, preferably the first mounting assembly comprises two first mounting units at opposite sides of the longitudinal axis of the vehicle.

While the footplate could in principle be mounted to the chassis only using the first mounting assembly, with the end of the footplate most distal from the first mounting assembly effectively floating free of the chassis, preferably the footplate is mounted to the chassis by a second mounting assembly, the second mounting assembly being closer to the rear of said vehicle than the first mounting assembly, and wherein the second mounting assembly constrains the footplate to move between a lowered position and a raised position. This makes the mounting of the footplate to the chassis more robust, and inhibits the footplate from moving in either direction beyond its natural upper and lower positions. The second mounting assembly may comprise one or more second mounting units each comprising a first part fixedly attached to one of the chassis and the footplate and a second part fixedly attached to the other of the chassis and the footplate, the first part and the second part being slideably engaged with each other. While the second mounting assembly could comprise only a single mounting unit, for example mounted at the longitudinal axis of the vehicle, preferably the second mounting assembly comprises two second mounting units at opposite sides of the longitudinal axis of the vehicle. The first part may comprise a slot and the second part may comprise a member (for example a bolt or tab) engaged within the slot.

Preferably, the footplate is biased into a lowered position when no obstacle is in contact with the underside of the footplate. The footplate may be biased into this position in a number of ways. For example, the footplate may be biased into the lowered position by gravity (i.e. the weight of the footplate). Alternatively, the footplate may be biased into the lowered position by pressure applied by the rider's feet. These two techniques do not require a specific biasing structure. Alternatively, a spring may be provided, wherein the spring biases the footplate into the lowered position. The spring may be a torsion spring, a first end of the torsion spring being attached to the footplate and a second end of the torsion spring being attached to the chassis. Alternatively or in addition to the spring, a resiliently compressible component may be mounted between the chassis and the footplate, the resiliently compressible material being under compression when the footplate is in the raised position. The resilient nature of the component will then tend to bias the footplate into the lowered position. In addition, the cushioning material may prevent the footplate from impacting forcefully against the chassis, which could potentially damage the mounting assemblies, chassis or footplate.

It is envisaged that the present invention would be particularly applicable to a three or four wheeled bike. While the vehicle described herein is entirely human or gravity propelled, in some alternative embodiments a motor may be provided to assist the human propulsion of the vehicle. However, even where a motor is present, such a vehicle is still human propellable if the rider is able to manually propel it by turning the rear wheels (for example).

It will be appreciated that while embodiments of the present invention are particularly beneficial for disabled riders, they can also be used by able bodied riders.

### DETAILED DESCRIPTION OF THE INVENTION

The invention will now be described by way of example with reference to the following Figures in which:

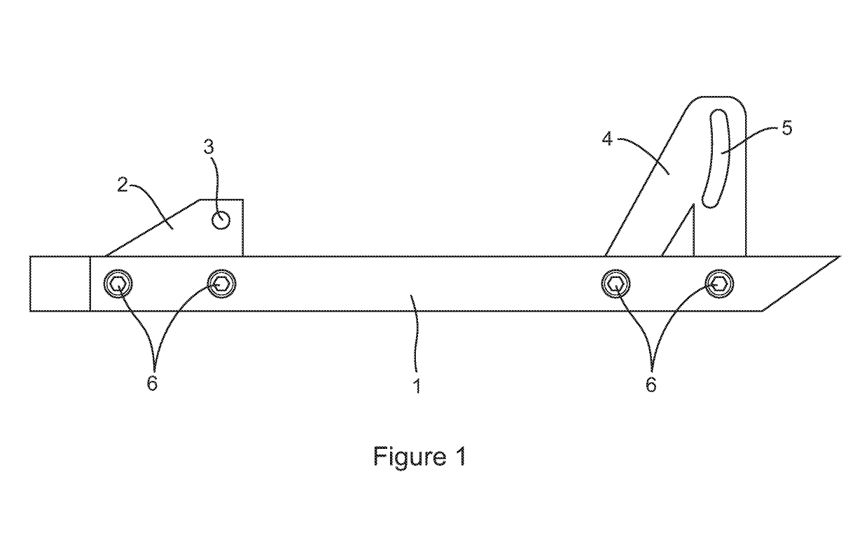

FIG. 1 schematically illustrates a side view of a footplate;

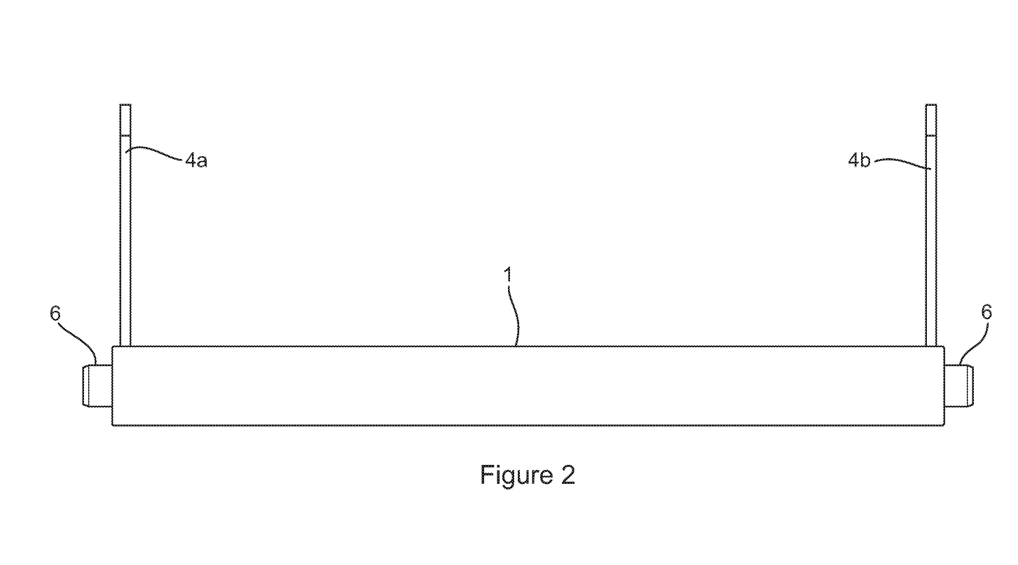

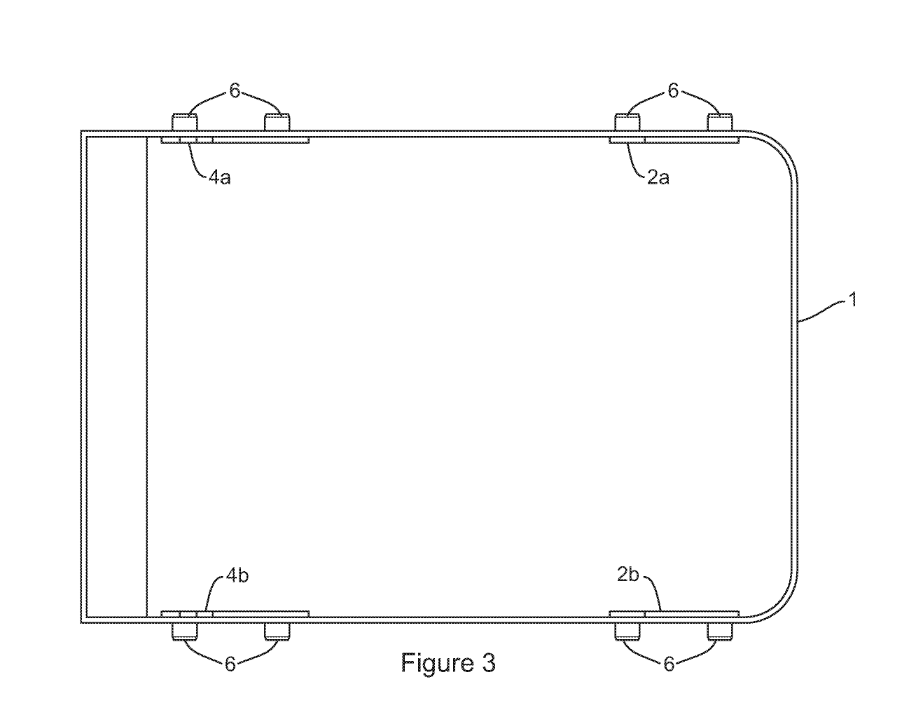

FIG. 2 schematically illustrates an end view of the footplate; FIG. 3 schematically illustrates a top view of the footplate;

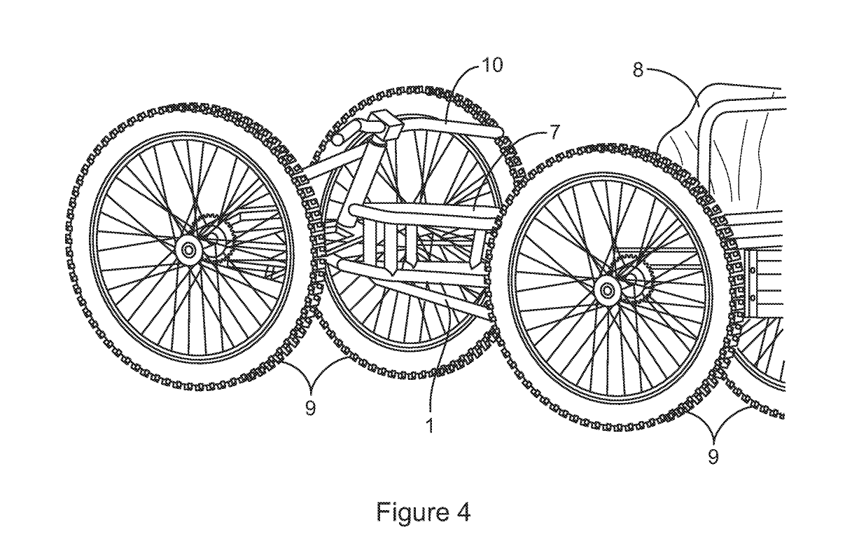

FIG. 4 schematically illustrates a 3D view of the human-propelled vehicle;

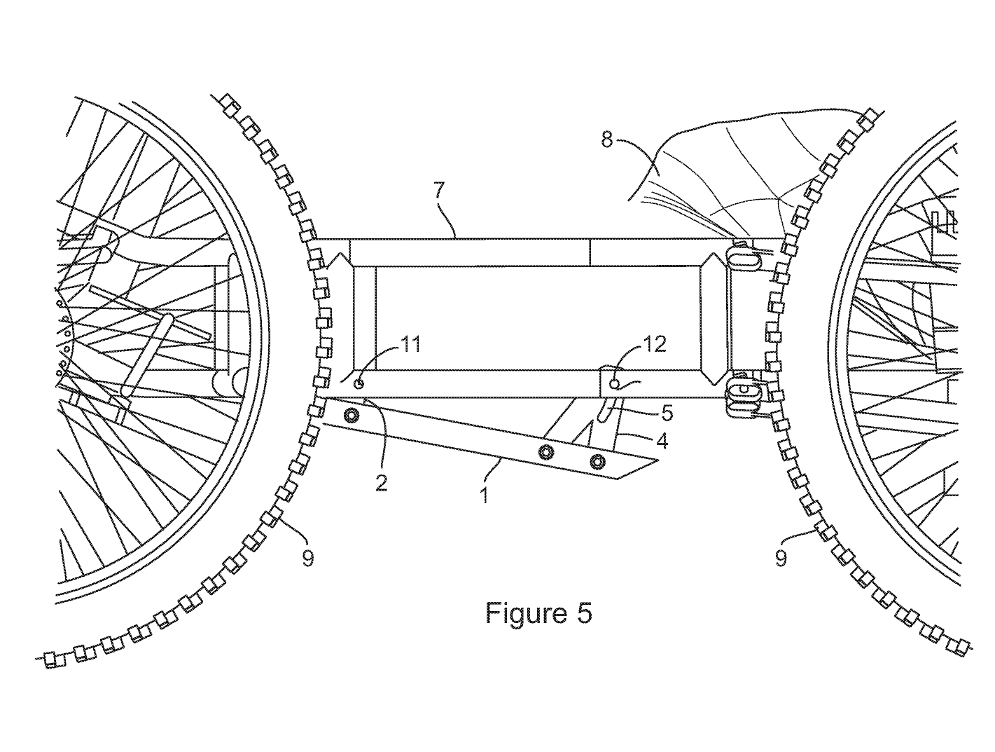

FIG. 5 schematically illustrates a side view of the human-propelled vehicle showing the footplate in the lowered position;

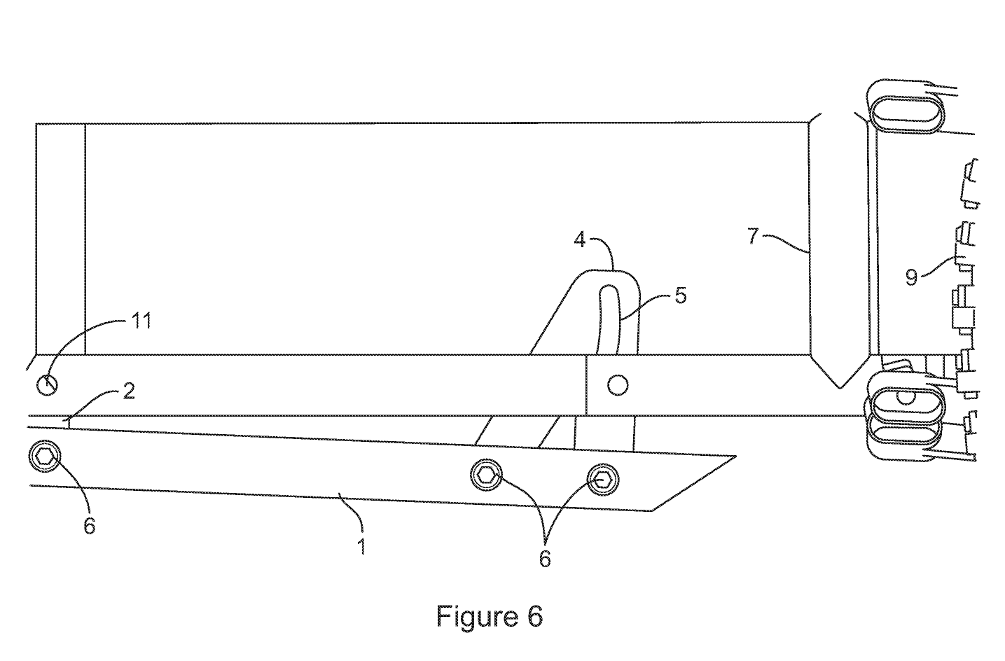

FIG. 6 schematically illustrates a close up side view of the human-propelled vehicle showing the footplate in the raised position;

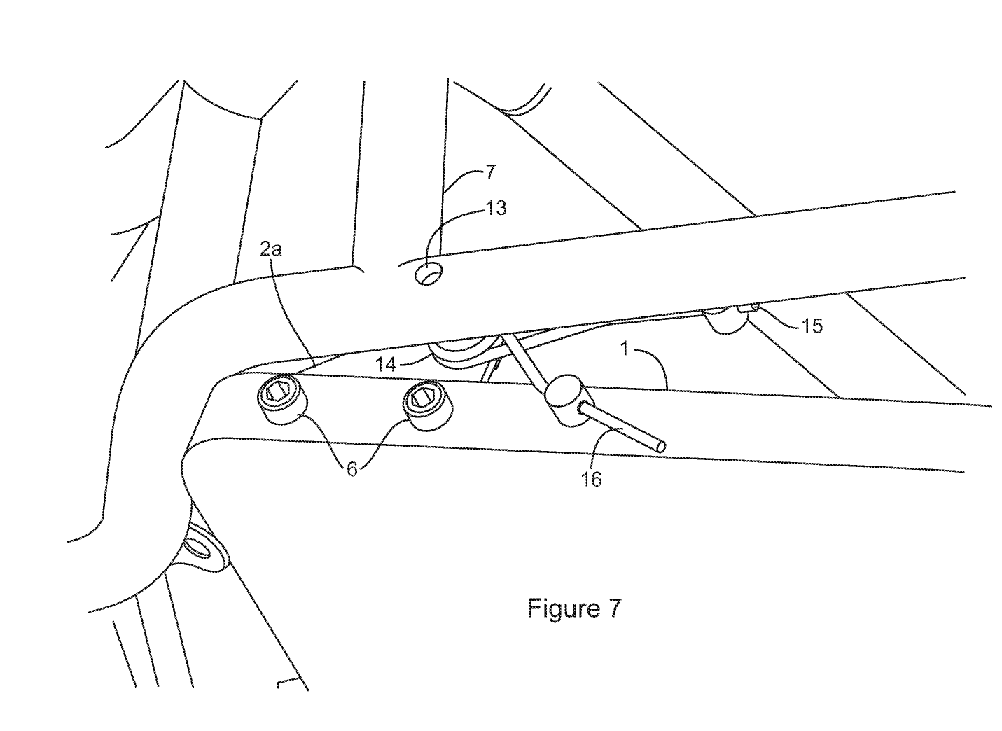

FIG. 7 schematically illustrates a close up view of the human-propelled vehicle showing a spring-biased mounting of the footplate to the chassis;

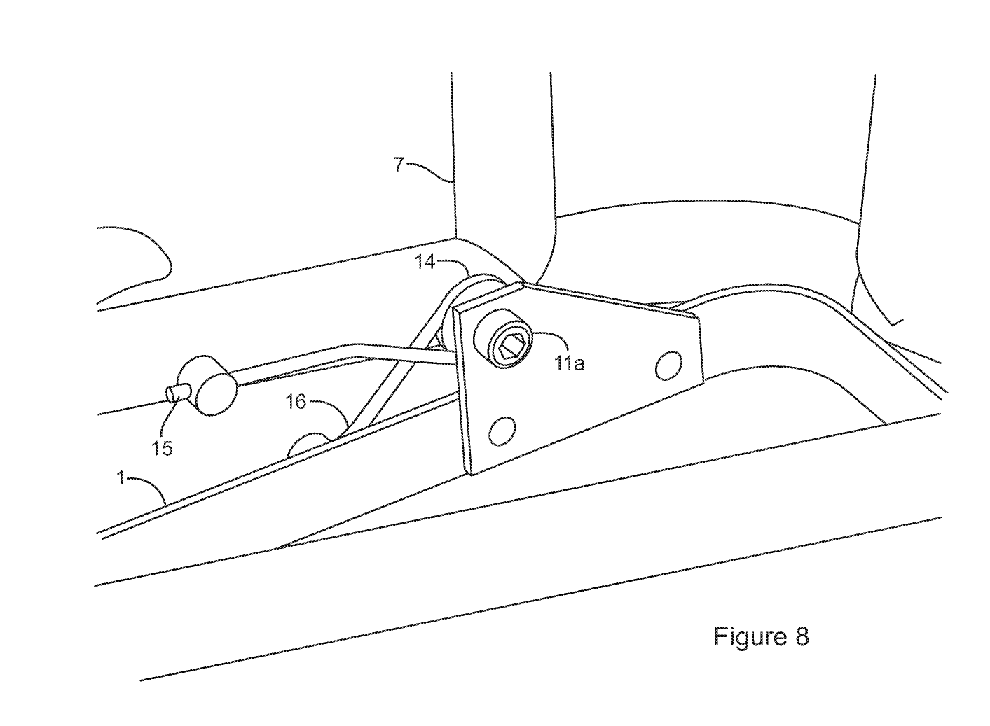

FIG. 8 schematically illustrates another close up view of the human-propelled vehicle showing the spring-biased mounting of the footplate to the chassis;

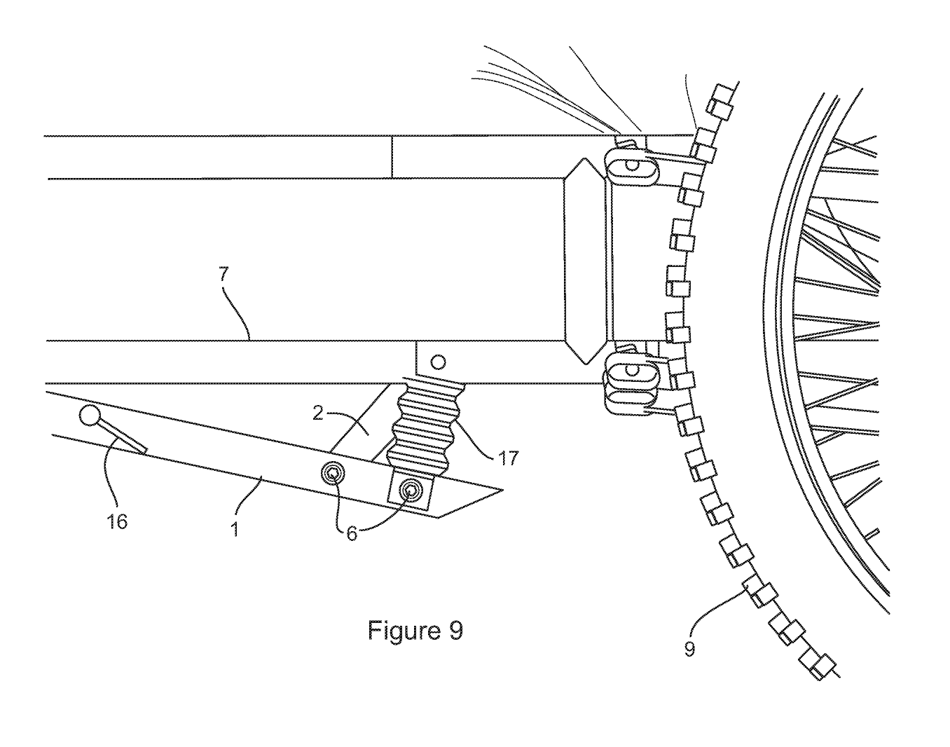

FIG. 9 schematically illustrates a side view of the human-propelled vehicle with a cushioning component mounted between the footplate and the chassis; and

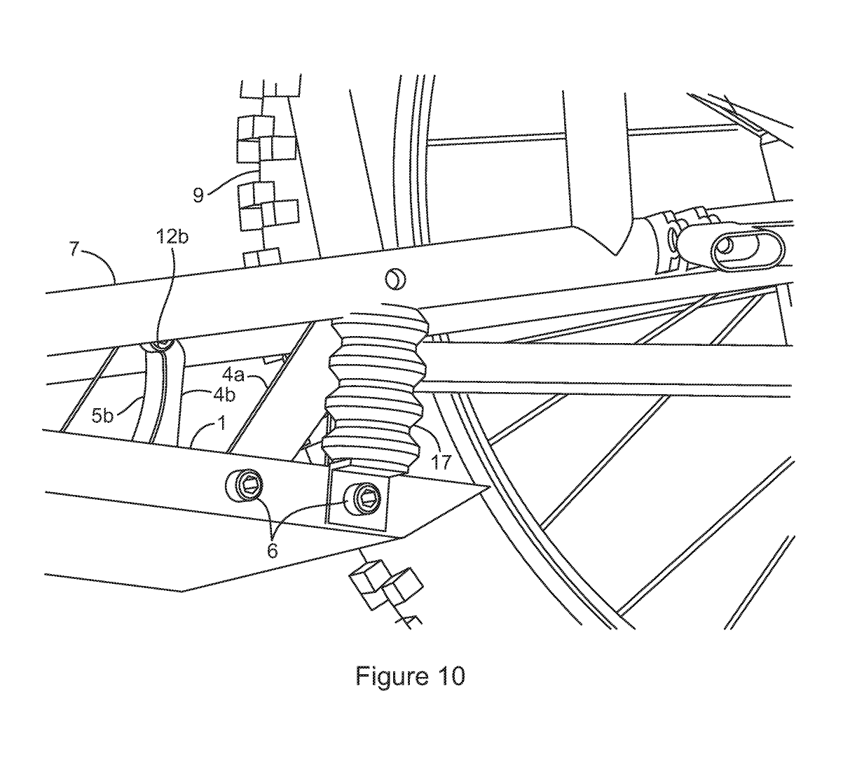

FIG. 10 schematically illustrates a close up view of the cushioning component between the footplate and the chassis.

Referring first to FIG. 1, a side view of a footplate 1 is shown. The footplate 1 is shown to have a front mounting bracket 2 attached to it towards a front end of the footplate 1. The front mounting bracket 2 has a hole 3 provided through it. The footplate 1 also has a rear mounting bracket 4 attached to it towards the rear end of the footplate 1. The rear mounting bracket 4 has an arcuate and generally vertical slot 5 provided through it. It will be appreciated that the front mounting bracket 2 having the hole 3 is closer to the front of the footplate than the rear mounting bracket 4 having the slot 5. Also visible in FIG. 1 are bolts 6 which fix the aforementioned front and rear mounting brackets 2, 4 to the footplate 1.

Referring to FIG. 2, a rear end view of the footplate 1 is shown. In this view, it can be seen that rear mounting brackets 4a, 4b are provided at each side edge of the footplate, and extend upright from the footplate 1. In the present case the rear mounting brackets 4a, 4b (and also the front mounting brackets) are mounted to the inside of the edge of the footplate, but it will be appreciated that they could equally be mounted to the outside of the edge of the footplate, or even to another part of the footplate 1 entirely. Front mounting brackets are similarly provided at each side edge of the footplate, but are obscured in FIG. 2 by the rear mounting brackets 4a, 4b. As with FIG. 1, bolts 6 are shown to fix the mounting brackets 4a, 4b to the footplate 1.

Referring to FIG. 3, a top view of the footplate 1 is shown. In FIG. 3, the footplate 1 is shown to be provided with a pair of front mounting brackets 2a, 2b, and a pair of rear mounting brackets 4a, 4b. For each of the front and rear pairs, one of the pair is mounted to one side of the longitudinal axis of the footplate 1 (and of the vehicle to which the footplate is attached, as will be discussed below), and the other of the pair is mounted to the other side of the longitudinal axis of the footplate 1 (and of the vehicle). Together, the first pair of mounting brackets 2a, 2b form part of a first mounting assembly (the other part of the first mounting assembly being attached to the vehicle, as will be described below), while the second pair of mounting brackets 4a, 4b form part of a second mounting assembly (the other part of the second mounting assembly being attached to the vehicle, as will be described below).

Referring to FIG. 4, a 3D view of a human-propellable vehicle to which the footplate 1 is mounted is shown. The vehicle is shown to comprise a chassis 7, the footplate 1, a seat 8, four wheels 9 and handle bars 10. Each of the footplate 1, the seat 8, the wheels 9 and the handlebars 10 are mounted to the chassis. The footplate 1 is shown to be angled downward relative to the chassis 7, defining the lowest point of the vehicle excepting the wheels 9. The footplate 1 adopts this low and angled position for maximum comfort for the rider of the vehicle, who sits in the seat 8 and rests their feet on the footplate 1. Unfortunately, this also means that the ground clearance of the vehicle is reduced, and the underside of the footplate 1 is relatively likely to collide with objects or terrain passing under the chassis and between the wheels 9.

Referring to FIG. 5, a side view of the human-propelled vehicle with the footplate 1 is shown. The seat 8, chassis 7, footplate 1 and wheels 9 of the vehicle are visible in FIG. 5. The footplate 1 is in its lowered, resting, position and is angled downward relative to the chassis 7. It can be seen clearly from FIG. 5 that the footplate 1, and most particularly the rear portion of the footplate 1, is closer to the ground than the chassis 7, and also closer to the ground than any other part of the vehicle except for the wheels 9. The footplate 1 is coupled or mounted to the chassis 7 by the front mounting assembly which comprises the front mounting bracket 2 having a hole (not visible) and a bolt 11 that extends horizontally through the hole in the front mounting bracket 2 and a hole in the chassis 7. The first mounting assembly permits pivoting of the footplate 1 about an axis of pivot defined by the bolt 11. The footplate 1 is shown to be further coupled to the chassis 7 by means of a second mounting assembly which comprises the mounting bracket 4 having the generally vertical slot 5 and a bolt 12 running through the vertical slot 5 and a hole in the chassis 7. The bolt 12 is slideably engaged with the generally vertical slot 5 which allows at least a part (the rear) of the footplate 1 to be vertically displaced relative to the chassis 7. It can be seen in FIG. 5 that the bolt 12 is engaged with the top portion of the slot 5, due to the fact that the footplate 1 is in its lowered, resting, position. The dimensions of the vertical slot control the range of movement of the footplate relative to the chassis. For example, a slot having a greater vertical length will allow greater deflection of the footplate compared to a slot having a shorter vertical length.

Referring to FIG. 6, a close up view of the footplate 1 in its deflected (raised) position is shown. In particular, while in FIG. 5 the bolt 12 was engaged with the top portion of the slot 5, in FIG. 6 the bolt 12 is engaged with the bottom portion of the slot 5. In other words, in FIG. 6 the footplate 1 is shown to have been vertically displaced upwards towards the chassis 7 when compared with FIG. 5. The footplate 1 is deflected from the position shown in FIG. 5 to the position shown in FIG. 6 when an object passes underneath the chassis (from the front) and collides with the underside of the footplate 1. This collision pushes the footplate 1 up and out of the way of obstacles towards the chassis 7 and the rider, such that the impact of the collision is substantially reduced and the object or terrain is able to pass under the vehicle without arresting its forward motion unduly, causing the vehicle to overturn or causing the footplate 1 to be damaged.

Referring to FIG. 7, a close up view of the vehicle of the present invention is shown with particular focus on the front mounting assembly. The front mounting assembly in this case comprises a first mounting bracket 2a having a hole (not visible) through which a bolt (not visible) is able pass to attach the mounting plate 2a to the chassis 7. A hole 13 on the chassis 7 to which the bolt (not visible) attaches is shown. The front mounting assembly permits pivoting of the footplate 1 about an axis of pivot at the position of the bolt (not visible) of the first mounting assembly, to rotate it up out of the path of obstacles under the chassis 7. The embodiment in FIG. 7 also comprises a torsion spring 14 which biases the footplate 1 towards the lower position. This means that the footplate 1 is always in its lowered position except when the underside of the footplate 1 comes into contact with an obstacle or terrain feature passing under the chassis 7, and also that the footplate 1 returns to the lowered position once the obstacle or terrain feature has passed behind the footplate 1. In order to achieve this, one end 15 of the torsion spring is attached to the chassis 7 and the other end 16 is attached to the footplate 1. The centre of the torsion spring 14 is aligned with the hole (not visible) in the mounting bracket 2a. The torsion spring 14 applies a torsional force to push the footplate 1 downwardly away from the chassis 7. It will be appreciated that a collision with an obstacle temporarily overcomes the torsional force to deflect the footplate 1 up towards the chassis 7.

Referring to FIG. 8, another view of the first mounting assembly of FIG. 7 is shown. From this view, the bolt 11a of the first mounting assembly is clearly visible, as is the chassis 7, footplate 1, and mounting bracket 2a of the first mounting assembly. The position of the centre of the torsion spring circling around the bolt 11a is also more clearly visible in FIG. 8. Preferably, a torsion spring is provided to each side of the longitudinal axis of the footplate 1 and vehicle, but it will be appreciated that it may be sufficient to provide the torsion spring only to one side.

Referring to FIG. 9, a side view of the human-propelled vehicle with a resiliently compressible component (cushioning component) 17 of a compressible/deformable material provided between the footplate 1 and the chassis 7 is shown. Also shown in this figure is a wheel 9 of the vehicle, a part of a torsion spring 14 that is associated with the front mounting assembly, and the rear mounting assembly. The rear mounting assembly is shown to comprise a mounting bracket 4. The resiliently compressible component, which may take the form of a shock absorber, may serve both to reduce the ferocity of the upwards deflection of the footplate 1 in the event of a collision, and also to bias the footplate 1 towards its lowered position. The cushioning material may be any material which is compressible on application of a compression force and which returns to its original shape after removal of the compression force. Preferably, the compression material comprises rubber.

Referring to FIG. 10, a close up view of the human-propelled vehicle with the cushioning component 17 between the footplate 1 and the chassis 7 is shown. The rear mounting assembly is shown to comprise two mounting brackets 4a, 4b. A generally vertical slot 5b of one of the mounting brackets is shown together with a bolt 12b extending through the vertical slot 5b. In FIG. 10, it can be seen that the cushioning component is mounted at its upper end to the chassis and at its lower end to the footplate 1 via an L-shaped bracket. Preferably, a cushioning component is provided to each side of the longitudinal axis of the footplate 1 and vehicle, but it will be appreciated that it may be sufficient to provide the cushioning component only to one side.

1. A human-propellable vehicle comprising a chassis and a footplate for receiving a rider's feet, the footplate being movably mounted to the chassis so that at least part of the footplate can be deflected up towards the rider in the event of a collision between the underside of the footplate and an object or terrain passing under the chassis.

2. A human-propellable vehicle according to claim 1, wherein the footplate is mounted to the chassis by a first mounting assembly, the first mounting assembly being arranged to permit the footplate to pivot about a substantially horizontal axis, the horizontal axis being perpendicular to the longitudinal axis of the vehicle.

3. A human-propellable vehicle according to claim 2, wherein the first mounting assembly comprises a hinge joint or a pivot joint.

4. A human-propellable vehicle according to claim 2, wherein the first mounting assembly comprises one or more first mounting units each comprising a first part fixedly attached to one of the chassis and the footplate and a second part fixedly attached to the other of the chassis and the footplate, the first part and the second part being hingedly or pivotally engaged with each other.

5. A human-propellable vehicle according to claim 4, wherein the first mounting assembly comprises two first mounting units at opposite sides of the longitudinal axis of the vehicle.

6. A human-propellable vehicle according to any preceding claim 1, wherein the footplate is mounted to the chassis by a second mounting assembly, the second mounting assembly being closer to the rear of said vehicle than the first mounting assembly, and wherein the second mounting assembly constrains the footplate to move between a lowered position and a raised position.

7. A human-propellable vehicle according to claim 6, wherein the second mounting assembly comprises one or more second mounting units each comprising a first part fixedly attached to one of the chassis and the footplate and a second part fixedly attached to the other of the chassis and the footplate, the first part and the second part being slideably engaged with each other.

8. A human-propellable vehicle according to claim 7, wherein the second mounting assembly comprises two second mounting units at opposite sides of the longitudinal axis of the vehicle.

9. A human-propellable vehicle according to claim 7, wherein the first part comprises a slot and the second part comprises a member engaged within the slot.

10. A human-propellable vehicle according to claim 6, wherein the footplate is biased into the lowered position by gravity.

11. A human-propellable vehicle according to claim 6, wherein the footplate is biased into the lowered position by pressure of applied by the rider's feet.

12. A human-propellable vehicle according to claim 6, further comprising a spring, wherein the spring biases the footplate into the lowered position.

13. A human-propellable vehicle according to claim 12, wherein the spring is a torsion spring, and wherein a first end of the torsion spring is attached to the footplate and a second end of the torsion spring is attached to the chassis.

14. A human-propellable vehicle according to claim 6, further comprising a resiliently compressible component mounted between the chassis and the footplate, the resiliently compressible material being under compression when the footplate is in the raised position.

15. A human-propellable vehicle according to claim 1, comprising at least three wheels.

16. A human-propellable vehicle according to claim 15, comprising four wheels.
